(19) United States
(12) Patent Application Publication
(10) Pub. No.: US 2025/0272753 A1
(43) Pub. Date: Aug. 28, 2025

(54) SHARED-PROFIT INVESTING

(71) Applicant: Soraya Depowski, Fort Myers, FL (US)

(72) Inventor: Soraya Depowski, Fort Myers, FL (US)

(21) Appl. No.: 18/857,578

(22) PCT Filed: Jun. 21, 2023
(86) PCT No.: PCT/US2023/025814

§ 371 Date: Oct. 17, 2024

Related U.S. Application Data
(60) Provisional application No. 63/355,479, filed on Jun. 24, 2022.

(51) Int. Cl. G06Q 40/06; G06Q 40/04

(52) U.S. Cl. CPC G06Q 40/06; G06Q 40/04

(57) ABSTRACT

An example system comprises at least one of a brokerage processor circuitry and a Shared-Profit Investing (SPI) processor circuitry. The at least one of the brokerage processor circuitry and SPI processor circuitry are to: receive information associated with a brokerage account and an SPI option, the SPI option being defined by processing protocols, split a first percentage of the total profit of the electronic vehicle and a second percentage of the total profit based on the processing protocols over a period of time, transfer the second percentage of the total profit from the brokerage processor circuitry to the SPI processor circuitry as transaction data, and transfer the second percentage of the total profit to a non-profit assessment (NPA) entity or third party entity.

### BACKGROUND

Charities and other non-profit entities often are supported by donations, which may involve active donations of funds. Actively donating can be time consuming and results in lower donations. Increasing donations can be beneficial for supporting the charities and providing additional benefits to the donator.

### BRIEF DESCRIPTION OF THE DRAWINGS

Various examples can be more completely understood in consideration of the following detailed description in connection with the accompanying drawings, in which:

FIG. 1 is an example system for providing a Shared-Profit Investing (SPI) option.

FIGS. 2A-2E are example flow diagrams for providing an SPI option using an example system.

FIGS. 3A-3C are example systems for providing an SPI option.

FIGS. 4A-4C are example circuitry for providing an SPI option.

### DETAILED DESCRIPTION

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary, and is not intended to limit what is presently disclosed. The features implemented in one example may be implemented in another example where logically possible. The specific details can be varied from and still be contemplated to be within the spirit and scope of what is being disclosed.

There is a broad need for addressing fundamental global issues such as extreme poverty and climate change, among other issues. Many non-profit entities and other types of third parties may provide services and/or programs to address charitable issues. Many investors desire to provide positive social and environmental impact in addition to receiving financial returns. However, funding for charities and other non-profit entities often require investors to actively donate funds, which may be time consuming and results in lower donations. Electronic vehicles, such as bonds, stocks, mutual funds, exchange-traded funds (ETFs), and private equity, among others, provide consumers with the opportunity to invest money in capital markets and private entities/assets and obtain profits therefrom. Examples of the present disclosure are directed to systems, methodologies, and/or devices used to provide a Shared-Profit Investing (SPI) option for investors having brokerage accounts to automate donations to non-profits and other third-party entities addressing social and environmental issues.

In some examples, investors may open a brokerage account or add the SPI option to an existing brokerage account with the brokerage entity, e.g., a brokerage firm, by registering an SPI account associated with an SPI entity. A brokerage entity may include and/or refer to a firm, company, and/or other type of organization that connects parties for exchanges or transactions of electronic vehicles, such as via the brokerage account. A brokerage account may include and/or refer to a financial account, such as an investment account, used to hold, buy, and/or sell various electronic vehicles, such as public and private assets or cryptocurrencies. Example brokerage accounts include individual accounts, joint accounts, standard brokerage accounts, private equity accounts, cryptocurrency accounts, cryptocurrency wallets, digital wallets, online wallets, virtual wallets, e-wallets, decentralized finance accounts, retirement accounts, education accounts, custodial accounts, self-directed accounts, robo-advisor accounts, managed accounts, directed accounts, discretionary accounts, taxable accounts, and tax-advantaged accounts, among other types of accounts.

An SPI option may include and/or refer to an SPI feature and/or service associated with an SPI account and/or a brokerage account that provides (e.g., donates) a set percentage of profit(s) and/or income (herein sometimes generally referred to as “profits” for ease of reference) of a select electronic vehicle(s) and/or, in some examples, a set percentage of the select electronic vehicle (e.g., an asset) of the brokerage account to at least one third party entity. In some examples, when a percentage of the electronic vehicle(s) is shared, a profit may not yet be realized by the investor when the donation is made. An SPI entity may include and/or refer to a non-profit, a firm, company, and/or other type of organization that provides SPI accounts and/or options. In some examples, the brokerage account and the SPI option may be associated with an investor-selected electronic vehicle. An electronic vehicle may include and/or refer to a financial instrument, which may be exchanged or transacted for electronically, such as stock shares, bonds, options, and other assets. In some examples, the (second) percentage of profits and/or income of the electronic vehicle donated as part of the SPI option may include a set percent (e.g., 0.5 percent), where the remaining or first percentage of profits and/or income of the electronic vehicle remains with the investor. In some examples, the (second) percentage donated as part of the SPI option is across all electronic vehicles (e.g., all underlying holdings) of the brokerage account of the investor, which may be referred to as “a second percentage of profits and/or income of the brokerage account”. In such examples, the amount donated may be variable depending on the amount of total profit. In some examples, the (second) percentage of profits and/or income of the electronic vehicle may include a set amount (e.g., $1 dollar, $5 dollars, $10 dollars), such that the percent of total profits donated as part of the SPI option may be variable depending on the amount of total profits.

The investor may trade in the brokerage account as they normally would and on an ongoing and periodic basis, processor circuitry operated by the brokerage firm (herein generally referred to as “the brokerage processor circuitry” for ease of reference) may, in some examples, automatically share a percentage of the total profits with the third party entity. In some examples, the brokerage system calculates the percentage of total profits and, in other examples, the SPI system calculates the percentage of total profits and communicates the percentage to the brokerage system. Further, the donations may be used by the investor for tax purposes, such as off-setting capital gains tax. The percentage of shared profits is set by the investor and then automatically provided without further investor action, which may increase donations to charitable third party entities. In some examples, the investor may select an impact goal that correlates with a set of third party entities. By selecting the impact goal, the set of third party entities that are donated to may be adjusted by the SPI entity (or non-profit assessment (NPA) entity) based on services and products provided by third party entities and without further investor action. For example, an NPA entity, such as The Life You Can Save®, may update the set of non-profit third party entities associated with a particular impact goal and may communicate the update to the SPI entity, which adjusts which third party entities are provided funds and without further investor action or action by the brokerage entity. An NPA entity may include and/or refer to a non-profit, company, and/or other type of organization that assesses non-profits, such as assessing the validity, expense ratios, revenue, and performance, among other assessments. Such SPI options may be analogized to crowdfunding, in which small amounts of donations are provided in large volumes that may add up quickly.

More particularly, there is an urgent need for innovative finance solutions to capitalize on the shift in investor consciousness and to provide easily accessible vehicles to channel private capital toward the implementation of charitable programs and services. The SPI option, in accordance with examples herein, provides direct capital toward data-driven, outcome-based programs, and automatically once the investor sets up the SPI option. Furthermore, in some examples, the brokerage account information, or at least a portion thereof, for the investor is maintained by the brokerage entity, and the financial (e.g., bank) account information of the third party entity is maintained by the SPI entity and/or by the NPA entity, which may provide greater data security for the investor and the third party entities. In various examples, added data security is thereby provided both to the investor and the brokerage entity, as no investor information and/or information from the brokerage entity, such as brokerage account, bank account, or other secure or personal information, is communicated to the third party entity and/or the NPA entity. Similarly, in some examples, data security is provided to the third party entities as minimal or no private information is communicated to the investor and/or the brokerage entity about the third party entity, such as financial account information. Additionally, the SPI entity and/or NPA entity provides the shared profits to approved third party entities which may provide greater control and verification of profits being shared with outcome-based programs and/or targeting a specific impact goal that the investor is interested in. For example, the approved third party entities may add credibility for the brokerage entity who may not be familiar with assessing such entities. The SPI option allows investors or their financial advisors to invest as usual, leveraging the full power of the capital markets, and automatically share a portion of their profits with approved non-profit entities on an ongoing basis. SPI empowers mainstream investors to become impact investors without changing any of their trading behavior.

As an example, the investor opens an SPI account at their existing brokerage entity and selects from a list of SPI-approved (or certified non-profits, meaning those non-profits available on the SPI platform) non-profits for receipt of shared profits. Again, the list of approved non-profits may be limited in some examples—this is to avoid diluting the shared funds and ensure that recipient non-profits have been vetted and deemed to be highly effective. The investor or financial advisor invests in the brokerage account as they normally would, thus controlling their risk/return profile. On an ongoing basis, a specified percentage of each realized gain (e.g., when they sell a stock or receive a dividend and/or interest payment) is automatically shared with the specified non-profit entity and/or entities. SPI donations may be tax-deductible in countries where this incentive structure exists. The SPI option provides a simple funding mechanism that opens the floodgates to channel financing to charities and other non-profits by unleashing the profitability of the capital markets and the power of collective action across global investors. Since investors do not have to change their trading behavior in order to do good, the barrier to entry is low.

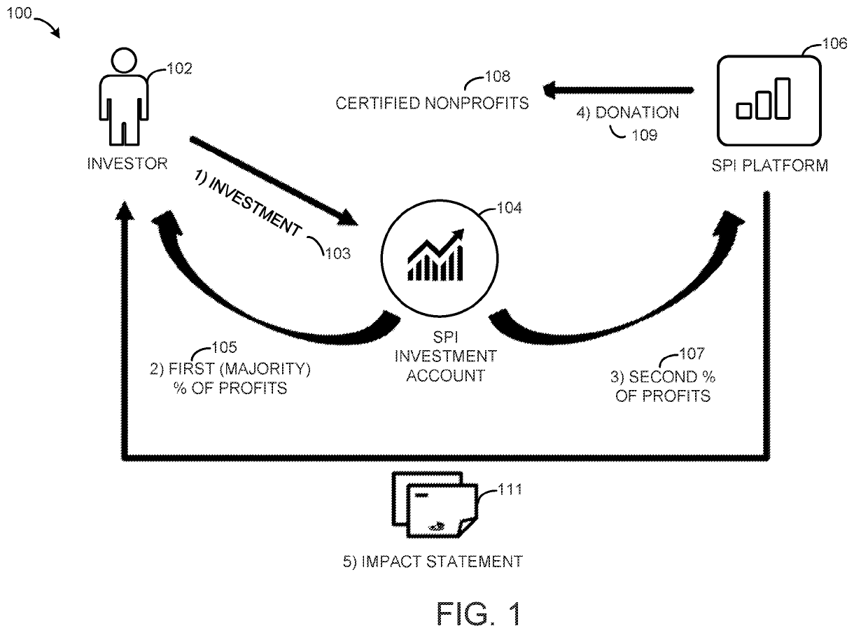

Turning now to the figures, FIG. 1 is an example system 100 for providing an SPI option. In some examples, the investor 102 first opens a brokerage account with the brokerage entity, as shown at 103. The brokerage entity may provide the option to register for an SPI option, as shown by SPI account 104, which may be added at the time of opening the brokerage account or after, and is optionally offered directly through the brokerage entity website. Upon selecting the SPI option, the investor 102 may select the processing protocols for the SPI option including at least one (or all) of the following (i) an impact goal and/or third party entity from a list of approved third party entities, (ii) the percentage of total profits, set amount of profits, or percentage or set amount of unrealized assets to be donated, and (iii) communication preferences. The communication preferences may include communication with the investor 102 by the SPI entity and/or the third party entities 108. For example, the communication preferences may include identification of an email account and the amount or timing of communication allowed.

In some examples, a brokerage processor circuitry (e.g., server) stores the processing protocols as associated with the brokerage account. In some examples, the brokerage processor circuitry transfers the shared profits and processing protocols to a processor operated by the SPI entity (e.g., server which form part of the SPI platform 106), herein referred to as “the SPI processor circuitry” for ease of reference, or to other circuitry. For example, the brokerage processor circuitry (or the SPI processor circuitry) may determine the amount of the (second) percentage 107 of the total profit to donate to the third party entity and may transfer the remaining portion of the total profit (e.g., the first percentage) to the investor 102 (e.g., to the brokerage account). In some examples, the SPI processor circuitry may determine the amount and communicate the determined amount of the second percentage 107 of the total profit to the brokerage processor circuitry. In some examples, the SPI entity, via the SPI processor circuitry, routes the donations 109 to the relevant third party entity or entities 108, generate an/or provides a donation receipt for and/or to the investor 102, and/or reports impact statistics (e.g., impact report) 111 for and/or to the investor 102 and/or the brokerage entity. In accordance with various examples, an investor 102 may include an individual user or a group of users investing using a brokerage account, such as an entity that is investing (e.g., company, non-profit entity, pension fund, group fund).

In some examples, while not illustrated by FIG. 1, an NPA entity may provide identifying information of third party entities 108 to the SPI entity or other entity, such as to the brokerage entity. For example, the NPA entity may assess different third party entities 108 and communicate the list of approved third party entities to the SPI entity (or other entity). The list may include identifying information and, optionally, routing information (or other bank account information) of the third party entities, such that the SPI entity (or other entity) may directly transfer funds to the approved third party entities 108 from the brokerage entity. However, examples are not so limited and, in some examples the SPI entity may communicate the routing information to the brokerage entity such that the brokerage entity may directly transfer funds. In some examples, the NPA transfers funds to the third party entities 108 and the routing information (or other bank account information) of the third party entities is not provided to the SPI entity, the investor 102, and/or the brokerage entity, as further described below.

In some examples, the list of approved third party entities may further include identification of groupings of approved third party entities associated with an impact goal. Non-limiting examples of impact goals include the following: (i) global health and disease (e.g., charities associated with improving the health of human lives, such as curing and preventing illness, reducing preventable deaths, curing reversible blindness, addressing disabilities, and providing access to health care); (ii) hunger and malnutrition (e.g., charities increasing access to food, providing essential nutrient supplementation, and providing farmers with education and tools to increase crop yields); (iii) clean water and sanitation (e.g., charities providing water conservation systems, water treatment solutions at local water sources, installing water dispensers, installing toilets or latrines, and providing handwashing facilities); (iv) reduced inequality (e.g., charities addressing inequality and various forms of discrimination such as race, gender, sexual orientation, economic status, and disability, and charities addressing child marriage, gender-based violence, and maternal/child health); (v) economic opportunity (e.g., charities providing cash transfers and Universal Basic Income programs, providing farmers with financing, training, and market facilitation to increase crop yields and maximize profits, and empowering economically disadvantaged people to start sustainable businesses via entrepreneurship training and financing); (vi) education (e.g., charities increasing access to early-childhood education, improving education quality, and addressing COVID-related impacts on education); (vii) lean and affordable energy (e.g., charities providing reliable access to energy created by sustainable solutions like solar panels); and (viii) climate change and conservation (e.g., charities driving innovation of carbon removal solutions and low-carbon technologies, advocating for climate-related policy change, preventing deforestation and other ecological destruction, conservation of animals and their habitats, etc.). In some examples, the specific third party entities which receive funds when an investor selects a particular impact goal and/or that are approved may be adjusted over time by the NPA entity and/or the SPI entity, without requiring further action by the investor 102 and/or the brokerage entity.

In some examples, the SPI entity may not be provided with all identifying information of the third party entities 108, such as not being provided with the routing or other bank account information. For example, the SPI entity may receive the transaction data, transfer the transaction data to the accounting subsystem and/or bank account of the NPA entity, and the NPA entity may transfer the transaction data to the bank account of the third party entity. Transaction data, as used herein, may include and/or refer to electronic information indicative of or including the funds and/or percentage of the total profits to transfer to the third party entity or entities for the SPI option.

As a specific example, directly with the brokerage entity, the investor 102 may open a brokerage account for an electronic vehicle associated with the brokerage entity and which includes the SPI option or the investor may add the SPI option to an existing brokerage account. The SPI option may be defined by processing protocols set by the investor 102 with the brokerage entity. For example, the investor 102 may select the processing protocols including providing the percentage 107 of the total profits or gains to at least one of third party entities 108. The processing protocols may include identification of the particular third party entity or an impact goal used by the SPI entity (e.g., via communicated data from the NPA entity) to automatically select the third party entity or a set of third party entities, a percentage of the total profits to provide, and identification of the investor 102. The brokerage processor circuitry may receive the selection of the processing protocols from an investor processor circuitry (e.g., computing device), and communicate the same to an SPI processor circuitry for registering the SPI account 104 and the processing protocols with the SPI entity. The brokerage processor circuitry may similarly store the processing protocols. In some examples, the identifying information, such as routing information, for the at least one third party entity may be stored by the SPI processor circuitry and not shared with the brokerage processor circuitry to provide security features and/or allow for greater flexibility in updating the SPI accounts. In some examples, the SPI processor circuitry may not be provided with the routing or financial account information of the third party entity. For example, the SPI processor circuitry may communicate the transaction data to the NPA entity, which transfers the transaction data to the at least one third party entity. Similarly, at least some identifying information, such as financial account or brokerage account information, for the investor may be stored by the brokerage entity and not shared with the SPI entity, NPA entity, and/or the third party entity to provide security features.

The brokerage processor circuitry may receive the information associated with the SPI account 104 and the SPI option including the processing protocols for the SPI option, set up the SPI option based on the processing protocols, split a first percentage 105 of a total profit of the electronic vehicle for the investor 102 and a second percentage 107 of the total profit for the at least one third party entity (of the entities 108) based on the processing protocols over a period of time. The second percentage 107 may be less than the first percentage 105, such as being a fraction of the first percentage 105. After the period of time, the brokerage processor circuitry may communicate and transfer the second percentage 107 of the total profit to an SPI processor circuitry (or other circuitry) as transaction data, wherein the brokerage processor circuitry and SPI processor circuitry (or other circuitry) are from disparate networks. In some examples, the SPI processor circuitry may calculate the percentages 105, 107 and communicate the same to the brokerage processor circuitry.

The SPI processor circuitry may receive the transaction data and route the second percentage 107 of the total profit to the at least one third party entity, and/or track the transaction data associated with the at least one third party entity and the brokerage account of the investor 102 and generate and/or provide a summary of the transaction to at least one of the investor 102 and to the brokerage entity. For example, the SPI processor circuitry may route the second percentage 107 of the total profit directly to a financial account of the at least one of the third party entities 108. Accordingly, in some examples, the processing protocol may identify the financial account associated with the at least one third party entity and/or a disparate processor circuitry to send the shared profits to the at least one third party entity, without the brokerage entity or the investor 102 being provided directly with the financial account or disparate processor information. The information may be identified by the SPI processor circuitry comparing the selected at least one third party entity or impact goal to a database of the SPI entity that is accessible to the SPI processor circuitry, and not by the brokerage processor circuitry or the investor processor circuitry. In other examples, the NPA processor circuitry may compare the selected at least one third party entity or impact goal to a database of the NPA entity that is accessible to the NPA processor circuitry.

In some examples, the SPI entity may route transaction data to a plurality of financial (e.g., bank) accounts associated with different third party entities 108 and which are associated with different disparate autonomous payment networks. The disparate autonomous payment networks may use different specific transaction processing protocols. The transaction data may include combined percentages of total profits from a plurality of different brokerage accounts and for each of the different third party entities over the period of time.

In various examples, the SPI processor circuitry communicates a list of approved third party entities or impact goals that are associated with the approved third party entities to the brokerage processor circuitry, the third party entities including non-profit and/or charitable entities. In some examples, the SPI processor circuitry generates and/or provides the summary of the transaction data to the investor as a donation receipt. In some examples and/or in addition, the SPI processor circuitry may track a total donation to the third party entity from a plurality of brokerage accounts, including the brokerage account. The donation receipt may include a summary of donations made by the investor via the SPI option and/or across a brokerage entity, such as a total amount donated and which may be used for tax purposes.

In some examples and as noted above, the SPI processor circuitry may not communicate data on the third party entities 108 to the brokerage entity and/or investor 102, other than communicating the summary report(s) (e.g., impact report) and/or donation receipt. In some such examples, an NPA processor circuitry may communicate the list of approved third party entities to the SPI processor circuitry, and the SPI processor circuitry may route the respective funds from the brokerage entity to the third party entities 108. In some examples and as noted above, the NPA processor circuitry may route the respective funds from the SPI entity (e.g., which receives or withdraws the funds from the brokerage entity) to the third party entities 108.

In various examples, the brokerage processor circuitry is configured to communicate the processing protocols including the identification of the at least one third party entity, identification of the investor 102, and identification of the second percentage 107, to the SPI processor circuitry and transfer the second percentage 107 of the total profit to the SPI processor circuitry as the transaction data. In some examples, the processing protocols may be based on a correlation of a set of third party non-profit entities that are to receive the second percentage 107 of the total profits based on an impact goal. In other examples or in addition, the processing protocols may identify specific third party entities 108.

Example are not limited to those that include an SPI entity and/or SPI processor circuitry. In some examples, the brokerage entity, NPA entity, and/or third party entity may perform the actions of the SPI entity. For example, a system may comprise at least one of a brokerage processor circuitry and an SPI processor circuitry. The at least one of the brokerage processor circuitry and SPI processor circuitry may receive information associated with a brokerage account and an SPI option including processing protocols for the SPI option. The SPI option may be defined by the processing protocols which include identification of a third party entity and a second percentage of total profit of an electronic vehicle of the brokerage account to provide to the third party entity. In some example, the investor processor circuitry may communicate with the brokerage processor circuitry to identify the brokerage account for an electronic vehicle associated with the brokerage entity and including the SPI option, such as opening the brokerage account or adding the SPI option directly with the brokerage entity or through the SPI entity. The at least one of brokerage processor circuitry and SPI processor circuitry may further: (i) split a first percentage of the total profit of the electronic vehicle for an investor of the brokerage account and the second percentage of the total profit for the third party entity based on the processing protocols over a period of time, (iii) after the period of time, transfer the second percentage of the total profit from the brokerage processor circuitry as transaction data, and (iii) transfer the second percentage of the total profit to an NPA entity or third party entity. In some examples, the brokerage entity may transfer the second percentage of total profit to circuitry other than the SPI processor circuitry, such as to the NPA processor circuitry or third party circuitry. As used herein, “other circuitry” refers to any of the various processor circuitries as described herein. In some examples, other circuitry includes processor circuitry associated with the NPA entity or the third party entity, sometimes respectively referred to as “NPA processor circuitry” and/or “third party processor circuitry”. In some examples, other circuitry includes the NPA processor circuitry, the third party processor circuitry, and/or the SPI processor circuitry. In some examples, other circuitry includes the NPA processor circuitry, the third party processor circuitry, and/or the brokerage processor circuitry.

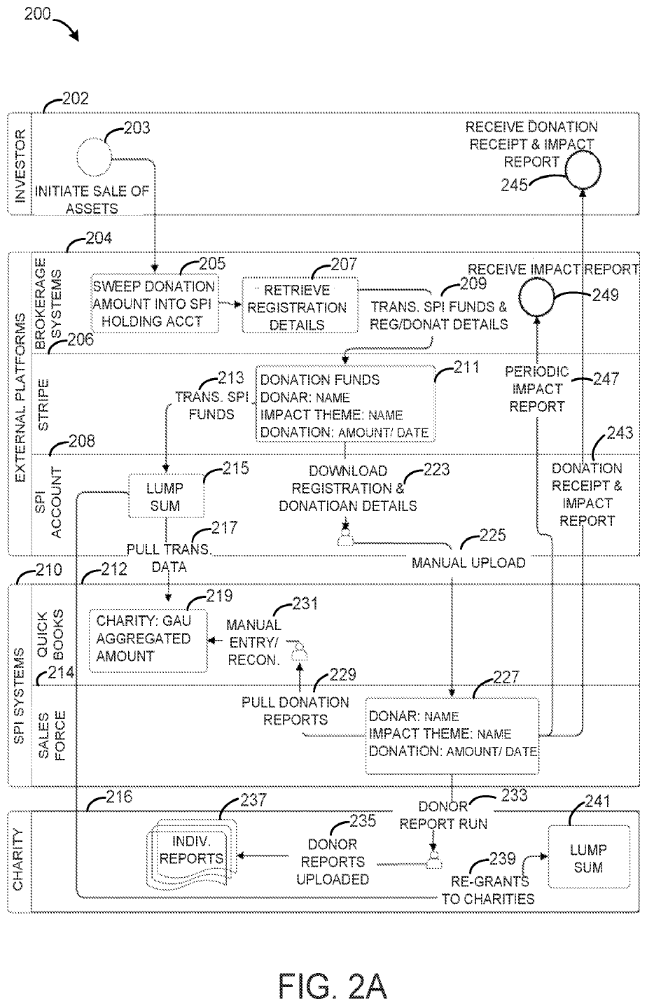

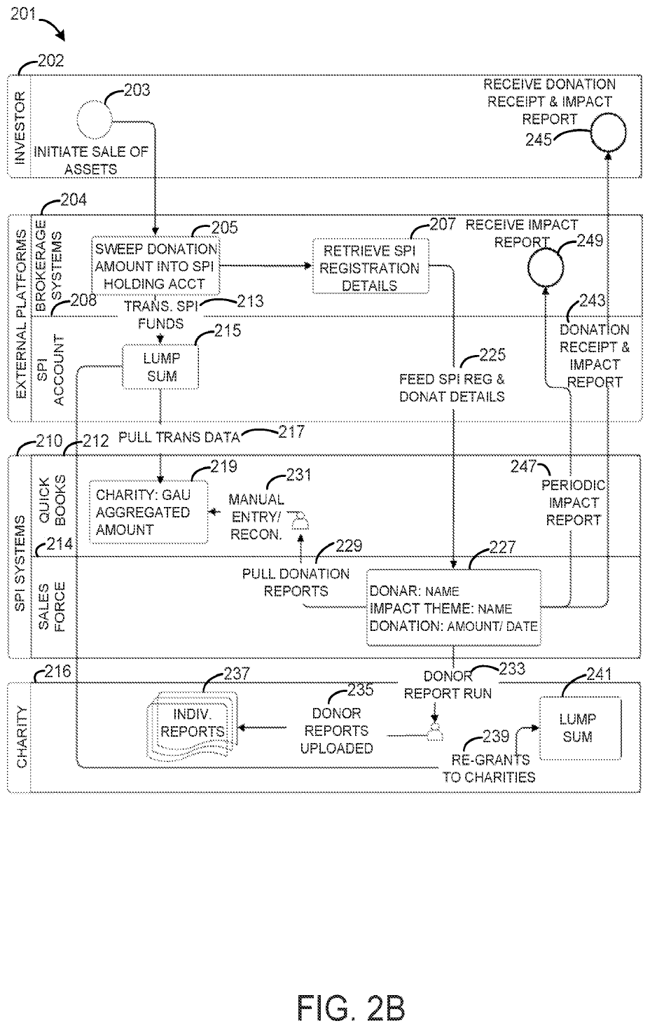

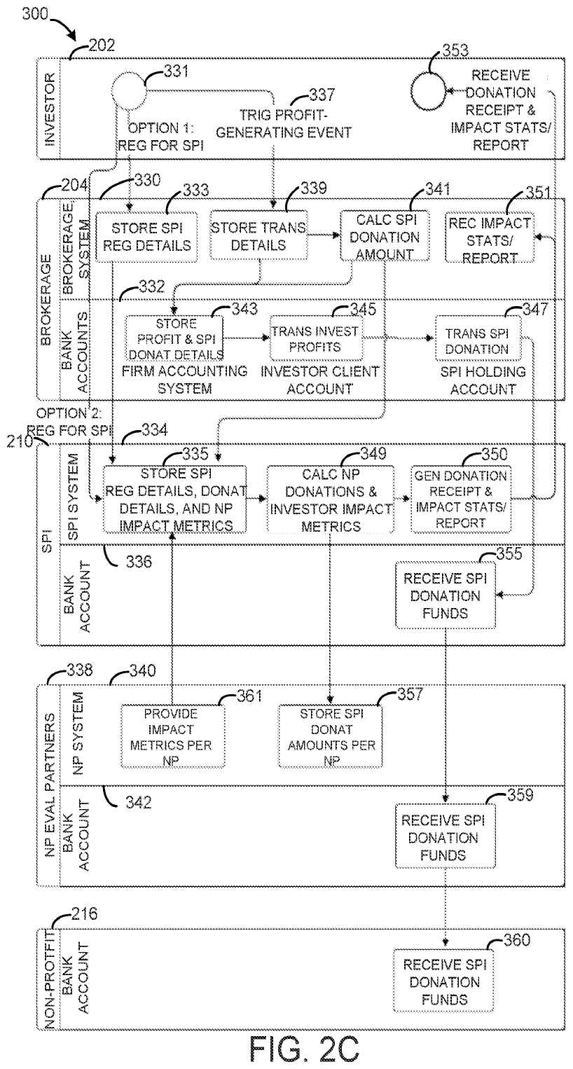

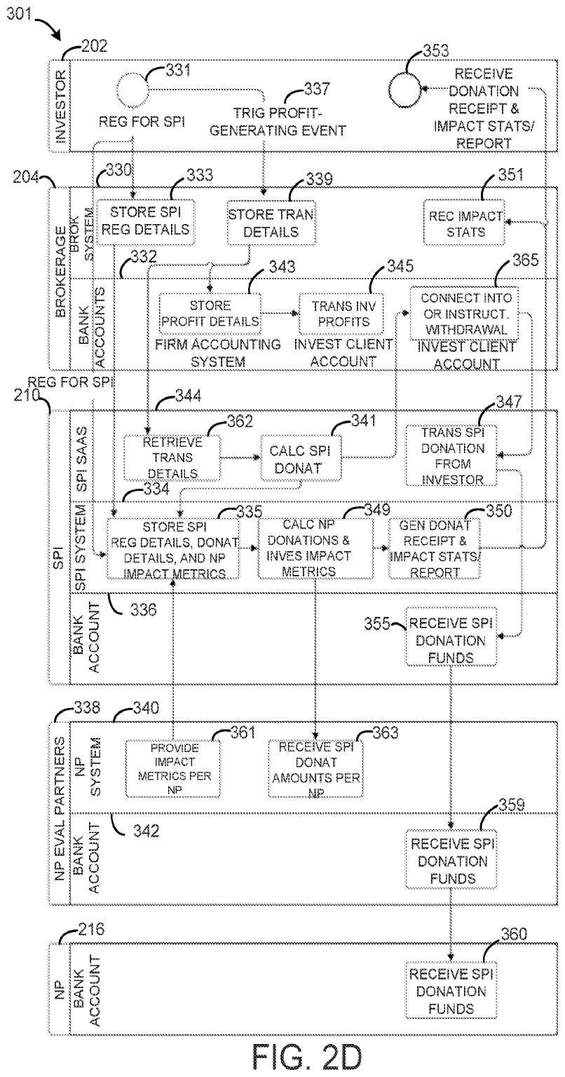

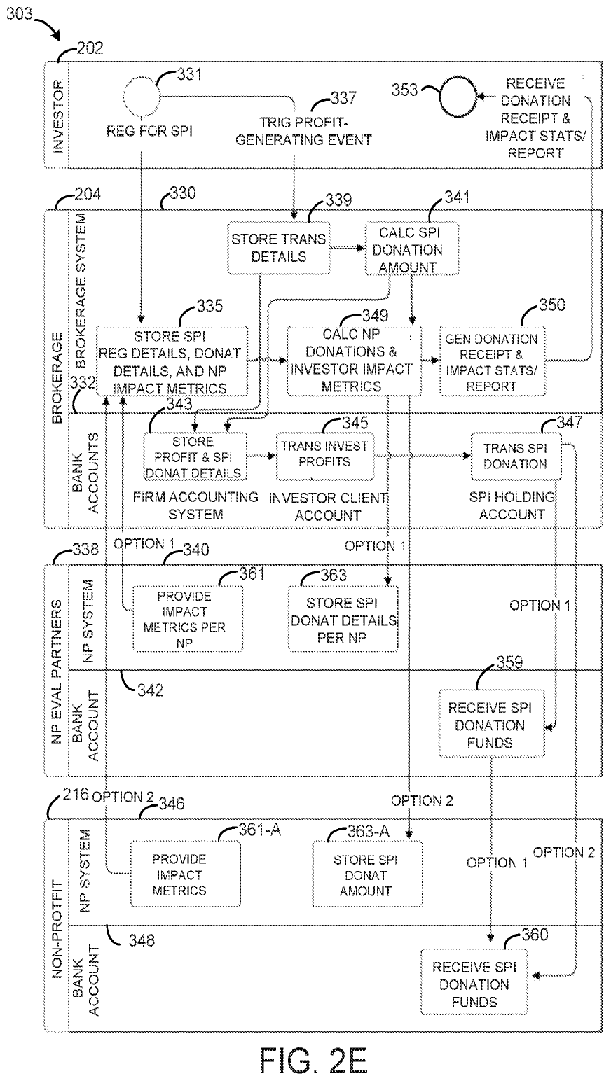

FIGS. 2A-2E are example flow diagrams for providing an SPI option using an example system. FIG. 2A shows an example flow diagram 200 with Stripe 206. And, FIG. 2B shows a similar flow diagram 201 without Stripe 206. In the event that Stripe 206 is not used for bulk transfer of SPI registration and donation details along with the shared profits, the brokerage entity (via brokerage systems 204, which is herein referred to generally as “brokerage entity 204” for ease of reference) may directly communicate the SPI registration and donation information to the SPI processor circuitry for storage on an SPI database, and/or may transfer the shared profits directly to the SPI bank account (via SPI systems 210, which is herein referred to as “SPI entity 210” for ease of reference). The following describes FIG. 2A, but a similar process may occur for FIG. 2B.

First, the investor 202 may receive a profit and/or income via sale of assets or receipt of dividend and/or interest, as shown at 203. The brokerage entity 204 (based on SPI percentage allocation settings set on the brokerage account and/or SPI account) may automatically calculate and auto-sweep funds into an SPI holding account (all managed/held within the brokerage system) or directly to the SPI entity (e.g., a financial account of the SPI entity), as shown by 205, 207, 209, 211, 212, and 215. In various examples, the SPI holding account, as used herein, is associated with a specific SPI entity. In other examples, the SPI holding account is associated with the NPA entity and/or a specific third party entity. The brokerage entity 204 may retrieve SPI registration details, as shown at 207, from the brokerage account (held within brokerage systems 204). Shared profits and investor SPI registration information may be transferred from brokerage system to Stripe 206, via SPI Stripe account, as shown by 211 and 213. In some examples, the SPI entity 210 transfers donation funds from the SPI Stripe account into an SPI financial account 208. In some examples, the SPI entity 210 pulls transaction data, at 217, from the SPI financial account 208 into QuickBooks 212. The SPI entity 210 may then pull investor SPI registration and donation details 223 (via month manual uploads 225) from Stripe 206 into Salesforce 214. Next, the SPI entity may generate and/or provide a donation receipt to the investor, as shown by 227, 229, 231. The SPI entity 210 may then perform reconciliation between QuickBooks 212 and Salesforce 214 to create receipts in QuickBooks 212 for individual donations. The SPI entity 210 (or NPA entity) may perform a periodic (wire) transfer of funds from SPI financial account 208 to each recipient third party entity 216, e.g., non-profit, as shown by lump sum 241. Further, the SPI entity 210 may send a periodic impact report 243, 247 to the investor 202 and brokerage entity 204. In some examples, the impact report(s) 243, 247 may be provided yearly, quarterly, monthly, or each time a donation is made, as shown by 245, 249. And, the SPI entity 210 may provide detailed donor reports 237 to recipient non-profits for investors who have elected to share their details during SPI registration, which may be provided periodically as shown by 235. The donor report may include and/or refer to contact details (such as name, address, phone number, email address) of the SPI investors, as well as donation dates and amounts. The impact report may include and/or refer to a document representing the impact statistics for donations made by the investor and/or brokerage entity for a period of time.

The following describes the flow diagram 300 illustrated by FIG. 2C, in accordance with various examples. An investor 202 may register for an SPI option by going to the brokerage entity website or directly to the SPI entity website. Based on the registration, the brokerage entity 204, using a brokerage processor circuitry (of brokerage system 330), may store registration information, as shown at 333, for the SPI option and SPI account on a brokerage database of the brokerage system 330 and may communicate the registration information to the SPI processor circuitry for storage on an SPI database of the SPI system 334, as shown at 335, or vice versa. In some examples where the investor 202 registers for an SPI option directly via the SPI entity website, the SPI registration information may be stored and maintained solely by the SPI entity 210 without involvement by the brokerage entity 204. The registration information may include the processing protocols for the SPI option, such as a percent of profits to provide (e.g., donate) for the SPI option (e.g., second percentage of the total profit), identification of at least one specific third party entity 216 or an impact goal, identification of the electronic vehicle or brokerage account to split the profits from, and information for communicating data (e.g., donation receipt, impact report) to the investor 202, among other information.

In some examples, the investor 202 may trigger a profit-generating event associated with the electronic vehicle and the brokerage account, or the profit-generating event may be automatically triggered, such as interest payments or dividends, as shown at 337. In response to the profit-generating event, the brokerage entity 204 (e.g., the brokerage processor circuitry of brokerage system 330) may store the transaction details of the profit-generating event, as shown at 339. The transaction details may include data identifying the electronic vehicle, profits, and/or profit-generating event, such as the total profit of the electronic vehicle associated with the profit-generating event and the type of transaction. The brokerage entity 204 may calculate and store the total profit and donation details (e.g., on a database associated with the brokerage accounting subsystem 332), and transfer the total profits to a brokerage account of the investor on the brokerage account subsystem, as shown by 341, 343, 345, 347. The donation details may include an indication or identification of funds to provide or donate and/or percent of the total profits, such as determined amount for donation, and in some instances, the impact goal or specific at least one third party entity. The brokerage entity 204 may calculate the donation details, e.g., the percent of the total profits to be transferred for the SPI option, and transfer the percent of the total profits to an SPI holding account of the brokerage account subsystem 332 (as shown by 341, 343, 345, 347) or directly to the SPI entity (e.g., a financial account of the SPI entity) as transaction data based on the transaction details and the processing protocols for the SPI option provided as the SPI registration information.

The SPI entity 210 may store (e.g., via an SPI database of the SPI subsystem) the registration information, donation details, and/or transaction details as received from the brokerage entity or directly from the investor 202 during registration on the SPI website, as shown by 335. The SPI entity 210 may further store impact metrics per non-profit third party entity, which may be received from the NPA entity, as shown by 361. Based on the donation details and impact metrics (e.g., 335, 361), the SPI entity 210 may calculate a breakdown of donations for each third party entity and total investor impact metrics, as shown by 349, and generates donation receipts and impact statistics per investor and, optionally, for the brokerage entity as a whole, as shown by 350. The donation receipts and per-investor impact statistics may be communicated to the investor 202 via the SPI entity 210 (e.g., from SPI processor circuitry to investor processor circuitry), as shown by 353, and optionally, impact statistics are communicated to the brokerage entity 204 (e.g., an impact report communicated from SPI processor circuitry to brokerage processor circuitry). For example, the brokerage entity 204 may be provided with total impact statistics across all investors of the brokerage entity 204 having an SPI account and associated SPI option with the SPI entity 210. In some examples, the donation receipts and impact statistics per investor are communicated from the SPI entity 210 to the brokerage entity 204, such as an impact report, and the brokerage entity 204 communicates to the investor 202.

As used herein, the impact metrics may include a representation of the donation-related impact of a donated amount. As an example, ten dollars may be used by a third party entity to cure twenty children of worm infections which improves nutrient absorption, mental and physical development, school attendance, and future economic prospects. In such an example, the impact metric stored in the SPI database may be: $0.50 cures 1 child of parasitic worm infections. As another example, ten dollars may be used by a third party entity to protect one hundred humans from the effects of iodine disorders via iodine supplementation. In such an example, the impact metric stored in the SPI database may be: $0.10 protects 1 person from effects of iodine disorders. The impact statistics may include a summary of impact metrics for an investor and/or a brokerage account over a period of time and, optionally, for multiple third party entities, and may be reported to the investor and/or brokerage entity as an impact report.

The SPI entity 210 may further communicate various data with an NPA entity 338. As noted above, the SPI entity 210 may receive the transaction data (e.g., transferred funds 355 received by the SPI accounting subsystem 336) and the donation and/or transaction details from the brokerage entity 204 (e.g., brokerage accounting subsystem 332) and, in some examples, transfers the transaction data to the NPA entity 338 (e.g., to the NPA accounting subsystem 342) and the NPA entity 338 transfers the transaction data to the specific third party entity 216 bank account(s), as shown by 359, 360. The transaction data may include total funds donated to the third party entity across multiple investors (e.g., a lump sum), in some examples. In some examples, the SPI entity 210 may transfer the transaction data directly to the bank account of the third party entity 216, such as via routing information. The SPI entity 210 may further communicate donation amounts per third party entity to the NPA entity 338 for tracking purposes, as shown by 357, and/or to calculate donation impact metric per third party entity using impact metrics 361 communicated from the NPA entity 338 (via NPA subsystem 340).

The flow diagram 301 illustrated by FIG. 2D is similar to that illustrated by FIG. 2C, but with the SPI entity 210 calculating the percent of profits to provide to the third party entity, as shown at 341. For example, as with FIG. 2C and as shown at 331, an investor 202 registers for an SPI option by going to the brokerage entity website or directly to the SPI entity website, with the relevant registration information provided to the SPI entity 210 or the brokerage entity 204 for storage, as shown by 333, 335. A profit-generating event occurs, as shown by 337, and the brokerage entity 204 may store the transaction details of the profit-generating event (e.g., on the brokerage system 330), as shown by 339, communicate transaction details to the SPI entity 210, as shown by 362, stores the transaction details in the brokerage accounting subsystem 332, as shown by 343, and transfers the total profits for the profit-generating event to the investor brokerage account of the brokerage accounting subsystem 332, as shown by 345. In some examples, the transaction details may include codes of the transaction and which indicate the total profit.

The SPI entity 210 may receive and/or retrieve the transaction details and calculates the donation details, e.g., indication or identification of funds that are a percentage of the total profits for donation for the SPI option for the investor, via a software as a service (SaaS) platform 344 of the SPI entity 210, as shown by 362, 341. Based on the calculation, the SPI entity 210 (e.g., SaaS platform 344) connects into or otherwise withdraws the transaction data, e.g., the percentage of the total profits for donations, as shown by 365, and transfers the transaction data from the investor brokerage account to the SPI entity 210 (e.g., SPI accounting subsystem 336), as shown by 347, 355. In some examples, the brokerage processor circuitry may provide (direct) access to the SPI processor circuitry to withdraw the transaction data (e.g., funds) from the brokerage account as stored on the brokerage accounting subsystem 332. The SPI entity 210 may transfer the transaction data (e.g., funds) to the NPA entity 338 (e.g., to the NPA accounting subsystem 342), and the NPA entity 338 transfers the respective portions of the transaction data, e.g., respective funds, to the relevant third party entity 216 (or entities), as shown by 359, 360. As with FIG. 2C, examples are not so limited and in some examples, the SPI entity 210 may transfer the transaction data directly to the third party entity 216 or entities.

As further consistent with FIG. 2C, the SPI entity 210 may store impact metrics per non-profit third party entity, which may be received from the NPA entity 338, as shown by 361. Based on the donation details and impact metrics, the SPI entity 210 calculates a breakdown of donations for each third party entity and total investor impact metrics, as shown by 335, 349, and generates donation receipts and impact statistics per investor and, optionally, for the brokerage entity as a whole, as shown by 350. As previously described, the impact statistics may be provided as an impact report, as shown by 351, 353. The SPI entity 210 may communicate the SPI donation amount per non-profit entity to the NPA entity 338, as shown by 349, 363.

The flow diagram 303 illustrated by FIG. 2E is similar to that illustrated by FIGS. 2C-2D, but without the SPI entity 210. In some such examples, the previously described circuitry and actions of the SPI entity 210 may be performed by circuitry of the brokerage entity 204 and/or the NPA entity 338.

For example, as with FIGS. 2C-2D and as shown at 331 of FIG. 2E, an investor 202 may register for an SPI option by going to the brokerage entity website, with the relevant registration information provided for storage, as shown by 335. The registration information may include the SPI registration details, investor donation details, and/or non-profit impact metrics. A profit-generating event occurs, as shown by 337, and the brokerage entity 204 may store the transaction details of the profit-generating event (e.g., on the brokerage subsystem 330), as shown by 339, store the transaction details in the brokerage accounting subsystem 332, as shown by 343, and transfer the total profits for the profit-generating event to the investor brokerage account of the brokerage accounting subsystem 332, as shown by 345. The brokerage entity 204, via the brokerage accounting subsystem 332, may also transfer the transaction data associated with the SPI option (e.g., the second percentage) from the brokerage accounting subsystem 332 to the NPA entity 338 (e.g., NPA accounting subsystem 342) or to the third party entity 216 (e.g., third party accounting subsystem 348) as shown by 359 and 360.

In some examples, the brokerage entity 204 may use the transaction details (e.g., 339) to calculate the donation details, e.g., indication or identification of funds that are a percentage of the total profits for donation for the SPI option for the investor 202, as shown by 341. Based on the calculation, the brokerage entity 204 (e.g., via brokerage subsystem 330) may transfer the transaction data, e.g., the percentage of the total profits for donation, as shown by 347, and transfer the transaction data from the investor brokerage account to the NPA entity 338 (e.g., NPA accounting subsystem 342) or to the third party entity 216 (e.g., third party accounting subsystem 348) as shown by 359, 360. In some examples, the brokerage processor circuitry may provide (direct) access to the NPA processor circuitry or third party processor circuitry to withdraw the transaction data (e.g., funds) from the brokerage account as stored on the brokerage accounting subsystem 332.

In some examples, the brokerage entity 204 may store impact metrics per non-profit third party entity, which may be received from the NPA entity 338, as shown by 361, and/or from third party entity 216, as shown by 361-A (via third party subsystem 346). Based on the donation details and impact metrics, the brokerage entity 204 may calculate a breakdown of donations for each third party entity and total investor impact metrics, as shown by 335 and 349, and generate donation receipts and impact statistics per investor and, optionally, for the brokerage entity as a whole, as shown by 350. As previously described, the impact statistics may be provided as an impact report, as shown by 353. The brokerage entity 204 may communicate the SPI donation amount per non-profit entity to the NPA entity 338 and/or the third party entity 216, as shown by 349, 363, 363-A.

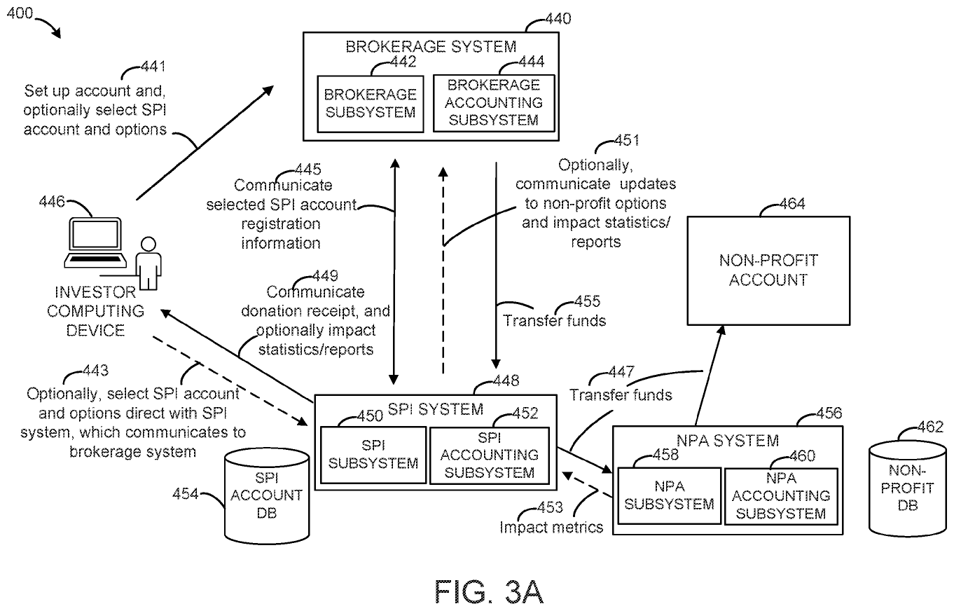

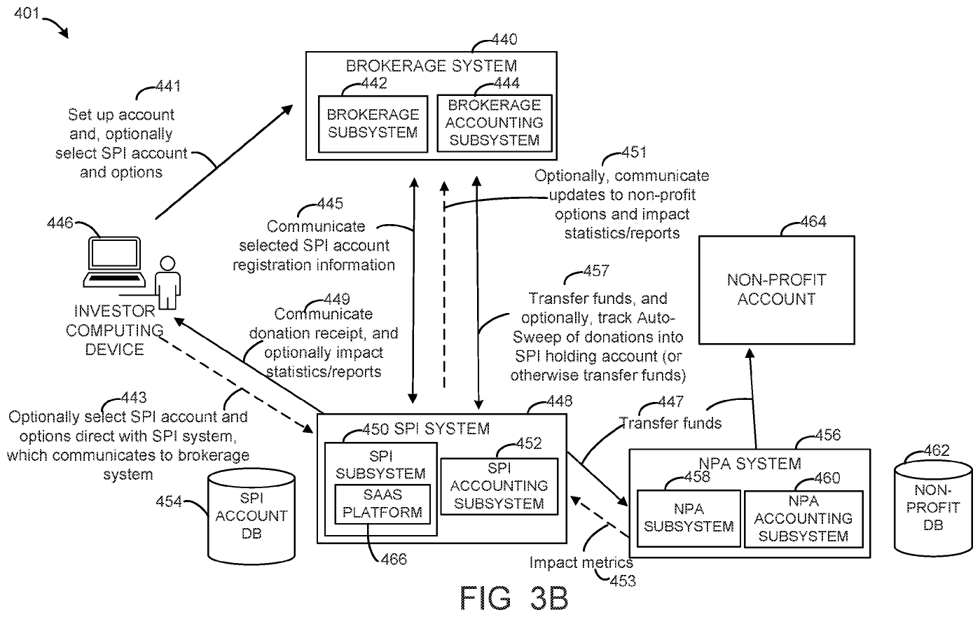

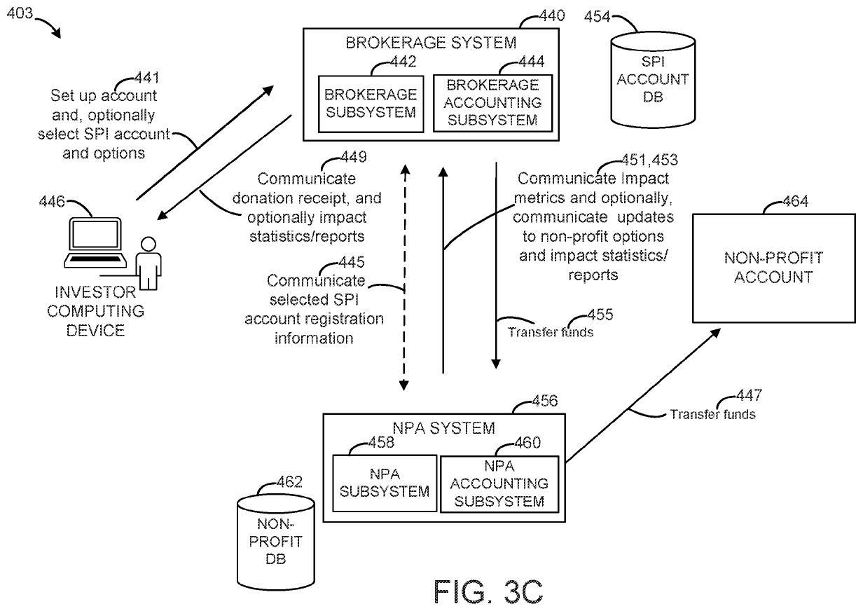

FIGS. 3A-3C are example systems for providing an SPI option. In some examples, the systems 400, 401, 403 illustrated by FIGS. 3A-3C may be used to implement the flow diagrams 200, 201, 300, 301, 303 illustrated by FIGS. 2A-2E. The investor, brokerage entity, SPI entity, NPA entity, and/or third party entity illustrated by FIGS. 2A-2D may include different systems used to implement the above flow diagrams and methods. For example, the investor may execute the registration (as shown by 441 and/or 443), triggering of the profit-generating event, and/or receive the donation receipt and impact report (as shown by 449) via a computing device 446. The computing device 446 may include processor circuitry and memory circuitry, as further described herein. Example computing devices include desktop computers, laptops, tablets, servers and smartphones. The brokerage entity, SPI entity, NPA entity and/or third party entities may include systems 440, 448, 456, 464 which each include subsystems 442, 444, 450, 452, 458, 460 and/or hardware which may be distributed, such as different processors, memories and/or databases. In some examples, one or more of the brokerage entity. SPI entity, NPA entity and/or third party entity systems 440, 448, 456, 464 include different subsystems 442, 444, 450, 452, 458, 460 which may be separate from one other or together, sometimes referred to as brokerage subsystem 442, SPI subsystem 450, NPA subsystem 458, brokerage accounting subsystem 444, SPI accounting subsystem 452, NPA accounting subsystem 460, and optionally, a third party subsystem. Each system and/or subsystem includes processor circuitry and, in some instances, memory circuitry. In various examples, the databases 454, 462 illustrated may be stored on the memory circuitry of the subsystem(s) 442, 444, 450, 452, 458, 460.

For example, in FIGS. 3A-3C, the investor may use a computing device 446 which includes processor circuitry (e.g., a processor or multiple processors) and memory circuitry. In some examples, the processor circuitry and/or memory circuitry may form part of or are in communication with other computing resources, such as a server which may communicate over a network. The memory circuitry (and any memory circuitry described herein) may include computer-readable medium storing a set of instructions. In some examples, the computer-readable storage mediums may include Read-Only Memory (ROM), Random-Access Memory (RAM), Electrically Erasable Programmable Read-Only Memory (EEPROM), flash memory, a solid state drive, Electrically Programmable Read Only Memory aka write once memory (EPROM), physical fuses and e-fuses, and/or discrete data register sets. In some examples, the computer-readable storage mediums may be a non-transitory storage medium, where the term “non-transitory” does not encompass transitory propagating signals.

In some examples, each of the systems 440, 448, 456, 464 and/or subsystems 442, 444, 450, 452, 458, 460 may include computing resources (e.g., processors and memory circuits) which are distributed and may communicate over a network, such as a cloud computing system or other type of network.

In some examples, the system 400 of FIG. 3A may be used to implement the flow diagram 300 of FIG. 2C. For example, an investor opens a new account with the brokerage entity or goes to existing brokerage account on the brokerage entity website, and the investor is offered to register the brokerage account for an SPI option. During SPI registration, either on brokerage entity website or SPI entity website, the investor specifies SPI option and account registration information, such as impact goal or specific third party entity, the percent of profits to be donated, specific electronic vehicles, type(s) of profit-generating events that result in profit split, and/or how to communicate with the investor (e.g., email communication preferences), as shown by 441, 443. If registering via SPI entity website, the SPI subsystem 450 may communicate SPI option and account registration information to brokerage subsystem 442, as shown by 445. If registering via brokerage entity website, brokerage subsystem 442 may communicate SPI option and account registration information to the SPI subsystem 450, as shown by 445. In some examples, the SPI subsystem 450 optionally communicates updates to third party entity options to the brokerage subsystem 442, such as new approved third party entities and/or new impact goals, as shown by 451. The investor or financial advisor may invest as usual and the brokerage system 440 automatically splits profits and income of electronic vehicles (e.g., investments) between the brokerage account of the investor and an SPI holding account (via brokerage accounting subsystem 444) or directly to the SPI entity based on the registration information and as transaction data. The brokerage system 440 may periodically transfer transaction data (e.g., donated funds) to the SPI system, as shown by 455, such as between the brokerage accounting subsystem 444 and the SPI accounting subsystem 452. The SPI system 448 may generate and/or provide the donation receipt for and/or to the investor, as shown by 449. In some examples, the NPA system 456 communicates impact metrics to the SPI system 448, as shown by 453, which the SPI system 448 may use to provide periodic impact statistics/reports to investor and brokerage entity to communicate the representative impact enabled by the donations, as shown by 449, 451. The SPI system 448 periodically transfers transaction data (e.g., donated funds), as shown by 447, and communicates recipient third party entity fund breakdown to the NPA system 456 and the NPA system 456 transfers transaction data (e.g., donated funds to approved (non-profit) third party entity financial account 464) according to the fund breakdown from the SPI system 448.

In various examples, the overall system 400 may include non-profit third parties which have bank accounts associated with different disparate, autonomous payment networks. The autonomous payment networks may have different network-specific payment processing protocols for facilitating electronic transfer of transaction data between different network (e.g., between the NPA accounting subsystem 460 and the bank account of the third party entity).

In some examples, the system 401 of FIG. 3B may be used to implement the flow diagram 301 of FIG. 2D. For example, an investor may open a new account with brokerage entity or goes to existing brokerage account on brokerage entity website, and the investor is offered the option to register the brokerage account for an SPI option, as shown by 441, 443 and via computing device 446. During SPI registration, either on brokerage entity website or SPI entity website, the investor specifies SPI option and account registration information. If registering via the SPI entity website, the SPI subsystem 450 may communicate SPI option and account registration information to the brokerage subsystem 442, as shown by 445. If registering via the brokerage entity website, brokerage subsystem may communicate SPI option and account registration information to the SPI subsystem, as shown by 445. In some examples, the SPI subsystem optionally communicates updates to third party entity options/impact goals to the brokerage subsystem, as shown by 451. The investor or financial advisor invests as usual and the SPI system automatically splits profits of electronic vehicles (e.g., investments) between the brokerage account of the investor and the SPI holding account or directly to the SPI entity based on the registration information and as transaction data, as shown by 457. In some examples, the SPI subsystem 450, via the SaaS platform 466, periodically withdraws and transfers transaction data (e.g., donated funds) from the brokerage system 440 to the SPI holding account or directly to the SPI entity, such as between the brokerage accounting subsystem 444 and the SPI accounting subsystem 452. The SPI system 448 may provide the donation receipt to the investor, as shown by 449. In some examples, the NPA system 456 communicates impact metrics to the SPI system 448, as shown by 453, and the SPI system 448 may use the impact metrics 453 to provide periodic impact statistics/reports to investor and brokerage entity to communicate the representative impact enabled by the donations. The SPI system 448 periodically transfers transaction data (e.g., donated funds) and communicates recipient third party entity fund breakdown to the NPA system 456 and the NPA system 456 transfers transaction data (e.g., donated funds to approved third party entity financial account 464) according to the fund breakdown from the SPI system 448, as shown by 447.

Although the figures and description provided above, including FIGS. 2A-2D and 3A-3B, show and describe separate brokerage, SPI, and NPA entities, examples are not so limited. In some examples, the brokerage entity and SPI entity may be part of the same entity, such that the above-described brokerage system and SPI system, and the related features and attributes, may be implemented as subsystems of a common system and entity as illustrated, for example by FIGS. 2E and 3C. In some examples, the SPI entity and NPA entity may be part of the same entity, such that the above-described SPI system and NPA system, and the related features and attributes, may be implemented as subsystems of a common system and entity. In some examples, the brokerage entity, the SPI entity, and the NPA entity, may be part of the same entity, such that the above-described brokerage system, SPI system, and NPA entity, and the related features and attributes, may be implemented as subsystems of a common system and entity. Accordingly, the above recitation of brokerage entity or system, SPI entity or system, and/or NPA entity or system may be replaced with brokerage subsystem, SPI subsystem, and NPA subsystem, and recitation of the subsystems may be replaced with sub-subsystems. e.g., brokerage sub-subsystem, brokerage accounting sub-subsystem, SPI sub-subsystem, and SPI accounting sub-subsystem.

Further, while the above-described examples include donation of a realized profit, a fixed percentage of a realized profit, and/or donation of profits by the investor, examples are not so limited. In various examples, the investor may donate an electronic vehicle, such as a percentage or specific quantity of an appreciated and unsold asset. In such examples, the investor donates an unrealized profit of a currently held security interest or other asset. In some examples, the investor may donate a percentage of total assets under management by the brokerage entity for the investor. For example, the current value of the brokerage account may be assessed periodically (e.g., monthly, quarterly, annually) and a set percentage or amount of the value may be deducted and donated from the brokerage account. In some examples, the investor may donate a percentage of total unrealized profits, such as an unrealized gain, of the total assets under management by the brokerage entity for the investor. For example, the current unrealized profits of the brokerage account may be assessed periodically (e.g., monthly, quarterly, annually) and a set percentage or amount of the value may be deducted and donated from the brokerage account. In the above-described examples, the SPI option may operate similar to a type of account management fee that the investor pays the brokerage entity. In some such examples, the profit-generating event includes the periodic time that the current value of the brokerage account is assessed, with the profit generated being unrealized for the investor. In some examples, the investor may donate a fixed amount, rather than percentage of profit, per period (e.g., monthly, quarterly, annually).

In some examples, the brokerage entity may share profits, in addition or alternatively to the investor(s) of the brokerage entity. For example, the brokerage entity may offer a promotion to encourage investors to sign up for a SPI account and/or may otherwise donate a percentage of account management fees, or other types of funds, to the investor-selected impact goal and/or at least one third party entity associated with an SPI account. In some examples, the brokerage entity may donate a percentage of the account management fees of ongoing funds received from all investors and may donate to a brokerage-selected impact goal and/or at least one third party entity. In some examples, for certain funds, the brokerage entity may enable investors to optionally register for the SPI account and select the impact goal and/or at least one third party entity, after which the brokerage entity donates a percentage of the account management fees received from the respective investors brokerage accounts to the investor- or brokerage entity-chosen impact goal and/or at least one third party entity.

In some examples, the investor and/or brokerage entity may set a maximum donation amount per period of time (e.g., monthly, quarterly, yearly) to donate and/or may set different maximums for different period of times. The maximum donation amount may be set at the investor level (e.g., investor based) and/or the brokerage entity.

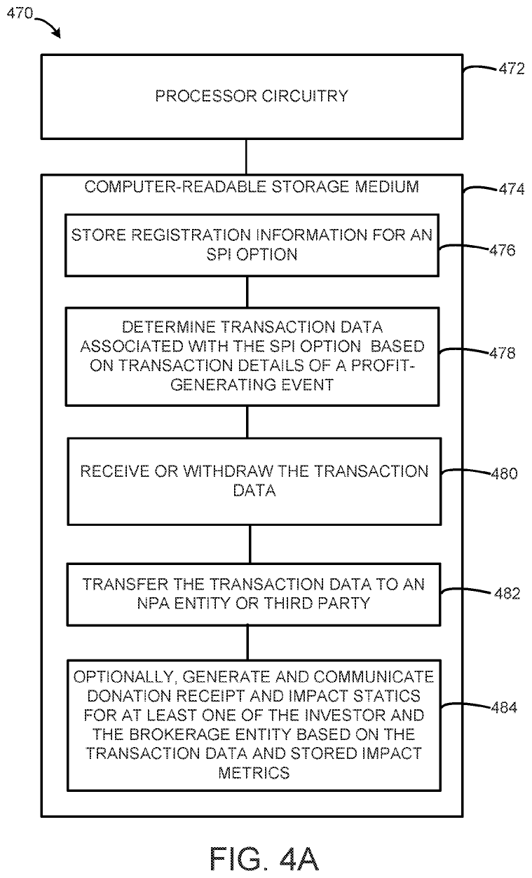

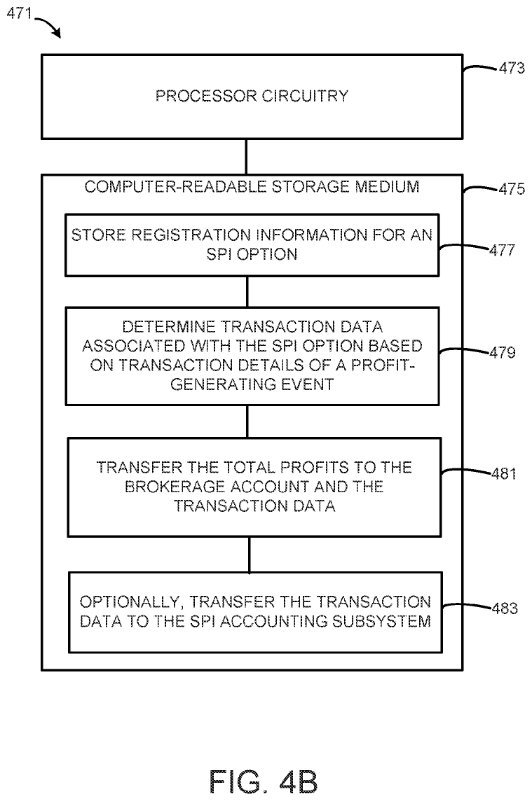

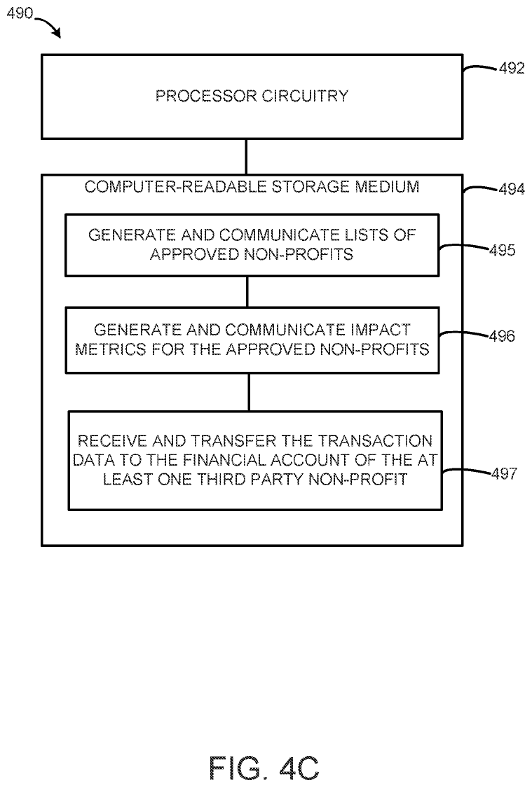

In some examples, the system 403 of FIG. 3C may be used to implement the flow diagram 303 of FIG. 2E. For example, an investor may open a new account with brokerage entity or go to an existing brokerage account on brokerage entity website, and the investor is offered the option to register the brokerage account for an SPI option, as shown by 441, and via computing device 446. During SPI registration, either on brokerage entity website or another website, the investor specifies SPI option and account registration information. If registering via the NPA entity website or other websites, the NPA subsystem 458 may communicate SPI option and account registration information to the brokerage subsystem 442, as shown by 445. If registering via the brokerage entity website, optionally, the brokerage subsystem 442 may communicate SPI option and account registration information to the NPA subsystem 445, as shown by 445. In some examples, the NPA subsystem 458 optionally communicates updates to third party entity options/impact goals to the brokerage subsystem 442, as shown by 451. The investor or financial advisor may invest as usual and the brokerage system 440 automatically splits profits of electronic vehicles (e.g., investments) between the brokerage account of the investor and the SPI holding account or directly to the NPA entity (or the non-profit third party entity) based on the registration information and as transaction data, as shown by 455. In some examples, the NPA subsystem 458 periodically withdraws and transfers transaction data (e.g., donated funds) from the brokerage system 440 to the SPI holding account or directly to the NPA entity, such as between the brokerage accounting subsystem 444 and the NPA accounting subsystem 460. The brokerage system 440 may generate and/or provide the donation receipt for and/or to the investor, as shown by 449. In some examples, the NPA system 456 communicates impact metrics to the brokerage system 440, as shown by 453, and the brokerage system 440 may use the impact metrics to generate and/or provide periodic impact statistics/reports to investor and for the brokerage entity to indicate the representative impact enabled by the donations. The NPA system 456 may periodically transfers transaction data (e.g., donated funds) and communicates recipient third party entity fund breakdown to approved third party entity financial account 464) according to the fund breakdown from the brokerage system 440, as shown by 447. FIGS. 4A-4C are example circuitry for providing an SPI option.

FIG. 4A is from the perspective of an SPI entity (or a brokerage entity for examples that do not include an SPI entity). More particularly, FIG. 4A illustrates an example device 470 including processor circuitry 472 and memory. The memory may include a computer-readable storage medium 474 storing a set of instructions 476, 478, 480, 482, 484. In various examples, the processor circuitry 472 may be the “SPI processor circuitry” and/or the processor circuitry 472 and memory may be distributed resources, as further described herein. In some examples, the processor circuitry 472 may be the “brokerage processor circuitry”, such as in examples that do not include SPI processor circuitry and/or an SPI entity.

The computer-readable storage medium 474 (as well as the computer-readable storage mediums 475, 494 illustrated by FIGS. 4B and 4C) may include ROM, RAM, EEPROM, flash memory, a solid state drive, EPROM, physical fuses and e-fuses, and/or discrete data register sets. In some examples, computer-readable storage medium 474 (and/or 475, 494) may be a non-transitory storage medium, where the term “non-transitory” does not encompass transitory propagating signals.

At 476, the processor circuitry 472 may store information associated with a brokerage account and an SPI option. The information may include registration information for the SPI option, such as, but not limited to, processing protocols for the SPI option. The registration information may be provided by the investor directly to the SPI entity or to the brokerage entity (for examples not including an SPI entity) and/or communicated from the brokerage system (e.g., brokerage processor circuitry 473), and may be associated with an investor or with the brokerage entity. At 478, in some examples, the processor circuitry 472 may determine transaction data associated with the SPI option based on processing protocols and/or transaction details of a profit-generating event or as a percentage of an asset for a non-realized profit. For example, the transaction data may include the percentage of the total profit associated with the SPI option, which is determined based on transaction details associated with the electronic vehicle(s) and the processing protocol. The transaction details may be communicated to the processor circuitry 472 from the brokerage system, or may be retrieved by the processor circuitry 472. At 480, in some examples, the processor circuitry 472 may receive, or withdraw, e.g., retrieves, the transaction data from the brokerage account, such as the percentage of the profits associated with a profit-generating event or an asset (for non-realized profits) based on processing protocols, to an SPI accounting subsystem. In some examples, the processor circuitry 472 transfers the transaction data to an SPI holding account that is on the brokerage system, and transfers the transaction data to the NPA entity, such as in examples not including an SPI entity. At 482, the processor circuitry 472 may transfer the transaction data to an NPA entity for transferring to a third party entity or may transfer the transaction data to the third party entity directly. In some examples, at 484, the processor circuitry 472 generates and/or communicate a donation receipt and impact statistics for the investor and/or the brokerage entity based on the transaction data and stored impact metrics.

FIG. 4B is from the perspective of a brokerage entity. More particularly, FIG. 4B illustrates an example device 471 including processor circuitry 473 and memory. The memory may include a computer-readable storage medium 475 storing a set of instructions 477, 479, 481, 483. In various examples, the processor circuitry 473 may be the “brokerage processor circuitry” and/or the processor circuitry 473 and memory may be distributed resources, as further described herein.

At 484, the processor circuitry 473 may store information associated with a brokerage account and an SPI option including processing protocols for the SPI option, such as registration information for the SPI option. The registration information may be provided by the investor directly to the brokerage entity and/or communicated from the SPI system (e.g., SPI processor circuitry 472) or other circuitry, and may be associated with an investor or with the brokerage entity. At 479, in some examples, the processor circuitry 473 may determine transaction data associated with the SPI option based on transaction details of a profit-generating event or as a percentage of an asset (for non-realized profits). As previously described, the transaction data may include the percentage of the total profit associated with the SPI option which is determined based on transaction details associated with the electronic vehicle and the processing protocols. At 481, in some examples, the processor circuitry 473 may transfer total profits to the brokerage account associated with the investor and/or the transaction data to an SPI holding account, directly to the SPI accounting subsystem, or to other circuitry (e.g., NPA or the third party processor circuitry) based on the processing protocols. At 483, the processor circuitry 473 may optionally transfer the percentage of the total profits to the SPI accounting subsystem or other circuitry as the transaction data.

FIG. 4C is from the perspective of an NPA entity. More particularly, FIG. 4C illustrates an example device 490 including processor circuitry 492 and memory. The memory may include a computer-readable storage medium 494 storing a set of instructions 495, 496, 497. In various examples, the processor circuitry 492 may be referred to as “NPA processor circuitry” and/or the processor circuitry 492 and memory may be distributed resources, as further described herein.

At 495, the processor circuitry 492 may generate and communicate at least one list of approved third party entities (e.g., non-profits). The list may be updated over time and periodically, or in response to the updates, communicated to the SPI system and/or the brokerage system. At 496, the processor circuitry 492 may generate and communicate impact metrics for the approved third party entities to the SPI system and/or the brokerage system. At 497, the processor circuitry 492 may receive and transfer at least a portion of the transaction data to at least one third party entity. For example, when the SPI processor circuitry 472 transfers the transaction data to the NPA system, the SPI processor circuitry 472 may additionally communicate data indicative of a breakdown of an amount (e.g., dollar or percentage) of the transaction data that is donated to each (or one) identified third party entity, e.g., a donated amount per third party non-profit entity based on processing protocols. Based on the breakdown provided by the SPI system, the processor circuitry 492 transfers the donated amount to each third party entity, which may be one or many third party entities per SPI option and may be transferred for multiple SPI options at a time.

While FIGS. 4A-4C illustrate a device 470, 471, 490, examples are not so limited. In some examples, one or more of the devices 470, 471, 490 forms part of a cloud computing system having a plurality of remotely-located and/or distributed computing devices. For example, although FIGS. 4A-4C illustrate a single processor circuitry 472, 473, 492 and a single computer-readable storage medium 474, 475, 494, examples are directed to devices and/or systems with multiple processors and multiple computer-readable storage mediums. The instructions may be distributed and stored across the multiple computer-readable storage mediums and may be distributed and executed by the multiple processors. In some examples, the processor circuitries 472, 473, 492 may form part of different systems or different parts of the same overall system.

Various examples are directed to methods, which may be implemented by any of the above-describe systems and/or circuitries. Examples methods may include any of the variations as described above.

Example methods include receiving information to identify a brokerage account for an electronic vehicle associated with a brokerage entity and including a SPI option, the SPI option being defined by processing protocols including identification of a third party entity and a second percentage of total profit of the electronic vehicle. In some examples, the method includes setting up the SPI option based on the processing protocols. The method may include splitting a first percentage of the total profit of the electronic vehicle for an investor of the brokerage account and the second percentage of the total profit for the third party entity based on the processing protocols over a period of time. The method may include, after the period of time, transferring the second percentage of the total profit from a brokerage processor circuitry to other circuitry as transaction data, and routing the second percentage of the total profit to a NPA entity or third party entity. In some examples, the other circuitry includes the SPI processor circuitry, the NPA processor circuitry, or third party processor circuitry.

In some examples, the method includes generating a donation receipt and/or impact statistics for the investor and/or generating a donation receipt and/or impact statistics for the brokerage entity. The method may include tracking the transaction data associated with the third party entity and the brokerage account of the investor and generating a summary of the transaction for at least one of the investor and a brokerage entity associated with the brokerage account. For example, the method may include providing a summary of the transaction to the investor and/or brokerage entity as the donation receipt. In some examples, the method includes tracking a total donation to the third party entity from a plurality of brokerage accounts including the brokerage account.

In some examples, the method includes communicating a list of approved third party entities or impact goals associated with approved third party entities between at least two of the NPA entity, brokerage entity, SPI entity, and the third party entities including non-profit entities, as previously described.

In some examples, the method includes, via the brokerage processor circuitry, communicating the processing protocols including identification of an impact goal or third party entity, identification of the investor, and identification of the second percentage, to the SPI processor circuitry or NPA processor circuitry, and transferring the second percentage of the total profit to the SPI processor circuitry or the NPA processor circuitry as the transaction data. In some examples, the method includes, via the SPI processor circuitry, communicating the processing protocols including identification of the second percentage to the brokerage processor circuitry, and communicating a determined amount of the second percentage of the total profit for the third party entity to the brokerage processor circuitry.

Examples can be implemented in accordance with U.S. Provisional Application No. 63/355,479, filed Jun. 24, 2022, entitled “Shared-Profit Investing”, which includes Appendices A-B, and to which benefit is claimed and each of which are fully incorporated herein by reference in their entireties. Examples herein and/or in the provisional application may be combined in varying degrees (including wholly). Examples discussed in the provisional application are not intended to be limiting to the overall disclosure, or to any part of the claimed disclosure unless specifically noted.

Terminology used herein is for the purpose of describing examples and is not intended to be limiting. As used herein, the singular forms “a”, “an” and “the” are intended to include the plural forms as well, unless the context clearly indicates otherwise. The terms “comprises” and/or “comprising,” when used herein, specify the presence of stated features, steps, operations, elements, and/or components, but do not preclude the presence or addition of other features, steps, operations, elements, components, and/or groups thereof. As used herein, the term “and/or” includes any and all combinations of the associated listed items and can be abbreviated as “/”.

As illustrated, various circuit-based building blocks may be implemented to carry out the operations and activities described herein, and/or shown in the block-diagram-type figures. These building blocks represent circuits that carry out one or more of these or related operations or activities. For example, in certain examples, the blocks are discrete logic circuits or programmable logic circuits configured to implement the operations/activities, as in the circuit modules/blocks (e.g., the brokerage processor circuitry, SPI processor circuitry or other processor circuitry and circuits) shown above. Such circuitry can be used together with other elements to exemplify how examples can be carried out in the form or structures, steps, functions, operations, activities, etc. In some examples, the circuits are discrete logic circuits or programmable logic circuits configured to implement the operations/activities, as may be carried out as shown in the figures. In some examples, such a programmable circuit is a computer circuit, including memory circuitry for storing and accessing a program to be executed as a set (or sets) of instructions (and/or to be used as configuration data to define how the programmable circuit is to perform), and a process as described herein used by the programmable circuit to perform the related steps, functions, operations, activities, etc. Depending on the application, the instructions (and/or configuration data) can be configured to be implemented in logic circuitry, with the instructions (whether in the form of object code, firmware or software) stored in and accessible from a memory (circuit).

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system, comprising:
at least one of a brokerage processor circuitry and a SPI processor circuitry configured to:
receive information associated with a brokerage account for an electronic vehicle associated with a brokerage entity and a Shared-Profit Investing (SPI) option, the SPI option being defined by processing protocols including identification of a third party entity and a second percentage of total profit of the electronic vehicle to provide to the third party entity;
split a first percentage of the total profit of the electronic vehicle for an investor of the brokerage account and the second percentage of the total profit for the third party entity based on the processing protocols over a period of time;
after the period of time, transfer the second percentage of the total profit from the brokerage processor circuitry as transaction data; and
transfer the second percentage of the total profit to a non-profit assessment (NPA) entity or third party entity.

2-3. (canceled)

4. The system of claim 1, wherein the brokerage processor circuitry is further configured to:
receive information associated with the brokerage account and the SPI option including the processing protocols for the SPI option; and
set up the SPI option based on the processing protocols.

5. The system of claim 4, wherein the brokerage processor circuitry is further configured to:
split a first percentage of the total profit of the electronic vehicle and a second percentage of the total profit for the third party entity based on the processing protocols over a period of time; and
after the period of time, communicate and transfer the second percentage of the total profit to the SPI processor circuitry or other circuitry as transaction data.

6. The system of claim 5, wherein the SPI processor circuitry or the other circuitry is further configured to:
route the second percentage of the total profit to the NPA entity or third party entity; and
track the transaction data associated with the third party entity and the brokerage account of the investor and provide a summary of the transaction to at least one of an investor associated with the brokerage account and a brokerage entity associated with the brokerage account.

7. The system of claim 1, wherein the SPI processor circuitry is further configured to:
receive information associated with the brokerage account and the SPI option including the processing protocols for the SPI option; and
set up the SPI option based on the processing protocols.

8. The system of claim 7, wherein the SPI processor circuitry is further configured to:
receive data indicating of the total profit of the electronic vehicle for the investor;
determine the second percentage of the total profit for the third party entity; and
transfer the second percentage of the total profit by withdrawing the second percentage from the brokerage processor circuitry.

9. (canceled)

10. The system of claim 1, wherein at least one of:
the SPI processor circuitry is further configured to communicate a list of approved third party entities or impact goals associated with approved third party entities to the brokerage processor circuitry, the third party entities including non-profit entities; and
an NPA processor circuitry is configured to communicate the list of approved third party entities or impact goals associated with approved third party entities to the SPI processor circuitry or to the brokerage processor circuitry.

11. The system of claim 1, wherein the brokerage processor circuitry is further configured to perform at least one of:
communicate the processing protocols including identification of an impact goal or third party entity, identification of an investor, and identification of the second percentage to the SPI processor circuitry or other circuitry; and
transfer the second percentage of the total profit to the SPI processor circuitry or the other circuitry as the transaction data.

12. The system of claim 1, wherein the SPI processor circuitry is further configured to perform at least one of:
communicate the processing protocols including identification of the second percentage to the brokerage processor circuitry; and
communicate a determined amount of the second percentage of the total profit for the third party entity to the brokerage processor circuitry.

13. The system of claim 1, wherein the SPI processor circuitry or an NPA processor circuitry is configured to provide a summary of the transaction to at least one of an investor and the brokerage entity as a donation receipt.

14-15. (canceled)

16. A non-transitory computer-readable storage medium comprising instructions that when executed cause processor circuitry to:
store information associated with a brokerage account and a Shared-Profit Investing (SPI) option including processing protocols for the SPI option, the SPI option being defined by the processing protocols including identification of a third party entity and a percentage of a total profit of an electronic vehicle of the brokerage account to provide to the third party entity;
determine transaction data including the percentage of the total profit associated with the SPI option based on transaction details associated with the electronic vehicle and the processing protocols; and
receive the transaction data from the brokerage account; and
transfer the transaction data to a non-profit assessment (NPA) entity or third party entity.

17-18. (canceled)

19. The non-transitory computer-readable storage medium of claim 16, further including instructions that when executed, cause the processor circuitry to track the transaction data associated with the third party entity and the brokerage account and provide a summary of the transaction to at least one of an investor associated with the brokerage account and a brokerage entity associated with the brokerage account.

20-21. (canceled)

22. The non-transitory computer-readable storage medium of claim 16, further including instructions that when executed, cause the processor circuitry to receive the transaction data by withdrawing the percentage from the brokerage account.

23. The non-transitory computer-readable storage medium of claim 16, further including instructions that when executed, cause the processor circuitry to perform at least one of:
communicate a list of approved third party entities or impact goals associated with approved third party entities to brokerage processor circuitry, the third party entities including non-profit entities; and
receive the list of approved third party entities or impact goals associated with approved third party entities from NPA processor circuitry.

24. The non-transitory computer-readable storage medium of claim 16, further including instructions that when executed, cause the processor circuitry to:
communicate the processing protocols including identification of the percentage to brokerage processor circuitry; and
communicate a determined amount of the percentage of the total profit for the third party entity to the brokerage processor circuitry.

25. (canceled)

26. The non-transitory computer-readable storage medium of claim 16, further including instructions that when executed, cause the processor circuitry to:
generate at least one of a donation receipt and impact statistics for an investor associated with the brokerage account; and
generate at least one of impact statistics and a donation receipt for a brokerage entity.

27. The non-transitory computer-readable storage medium of claim 16, further including instructions that when executed, cause the processor circuitry to track a total donation to the third party entity from a plurality of brokerage accounts, including the brokerage account.

28. A non-transitory computer-readable storage medium comprising instructions that when executed cause processor circuitry to:
store information associated with a brokerage account and a Shared-Profit Investing (SPI) option including processing protocols for the SPI option, the SPI option being defined by the processing protocols including identification of a third party entity and a percentage of total profit of an electronic vehicle of the brokerage account to provide to the third party entity;
determine transaction data including the percentage of the total profit associated with the SPI option based on transaction details associated with the electronic vehicle and the processing protocols; and
transfer the total profit to the brokerage account and the transaction data to SPI processor circuitry or other circuitry.

29-31. (canceled)

32. The non-transitory computer-readable storage medium of claim 28, further including instructions that when executed, cause the processor circuitry to receive, from the SPI processor circuitry or the other circuitry, at least one of:
a list of approved third party entities or impact goals associated with approved third party entities; and
a summary of a total donation to the third party entity from a plurality of brokerage accounts, including the brokerage account.

33. The non-transitory computer-readable storage medium of claim 28, further including instructions that when executed, cause the processor circuitry to:
communicate the processing protocols including identification of an impact goal or third party entity, identification of an investor, and identification of the percentage to SPI processor circuitry or other circuitry; and
transfer the percentage of the total profit to the SPI processor circuitry or the other circuitry as the transaction data.

34-43. (canceled)
